(19) United States
(12) Patent Application Publication
(10) Pub. No.: US 2025/0058258 A1
(43) Pub. Date: Feb. 20, 2025

(54) AIR FILTERS HAVING ANTI-MICROBIAL CHARACTERISTICS AND SYSTEMS AND METHODS OF MANUFACTURE THEREOF

(71) Applicant: ALONIM FILTERS MARKETING LTD., Rishon Le Zion (IL)

(72) Inventors: Itsik LEVY, Yavne (IL); Maor BEERI, Tel Aviv (IL); Israel AMAR, Ashkelon (IL); Avraham POLLAK, Kfar Saba (IL)

(73) Assignee: ALONIM FILTERS MARKETING LTD., Rishon Le Zion (IL)

(21) Appl. No.: 18/721,479

(22) PCT Filed: Dec. 20, 2022
(86) PCT No.: PCT/IL2022/051349

§ 371 Date: Jun. 18, 2024

(30) Foreign Application Priority Data
Dec. 21, 2021 (IL) 289218

(51) Int. Cl. B01D 39/16; B01D 46/00; B01D 46/10; B01D 46/52

(52) U.S. Cl. CPC B01D 39/1623; B01D 46/0028; B01D 46/10; B01D 46/521; B01D 2239/0258; B01D 2239/0442

(57) ABSTRACT

An air filter including at least one filter medium including sonochemically-deposited at least one of nanoparticles having anti-microbial characteristics and microparticles having anti-microbial characteristics, and a method for manufacturing an air filter including providing a roll of at least one filter medium, in a roll-to-roll manner, passing the at least one filter medium through a sonochemical bath for depositing therein at least one of nanoparticles having anti-microbial characteristics and microparticles having anti-microbial characteristics and thereafter, drying the at least one filter medium, including sonochemically-deposited at least one of nanoparticles having anti-microbial characteristics and microparticles having anti-microbial characteristics.

### REFERENCE TO RELATED APPLICATIONS

Reference is hereby made to Israel Patent Application Serial No. 289,218, filed Dec. 21, 2021 and entitled AIR FILTERS HAVING ANTI-MICROBIAL CHARACTERISTICS AND SYSTEMS AND METHODS OF MANUFACTURE THEREOF, the disclosure of which is hereby incorporated by reference and priority of which is hereby claimed.

### FIELD OF THE INVENTION

The present invention relates to air filters and system and method of manufacture thereof and more particularly to air filters having anti-microbial characteristics.

### BACKGROUND OF THE INVENTION

Various types of air filters having anti-bacterial characteristics are known in the art.

Various techniques for sonochemical coating of objects are described inter alia in the following publications: U.S. Pat. No. 9,315,937; U.S. Published Patent Application No. 2011/097957, PCT Published Patent Application No. WO 2014/181329; European Published Patent Application No. 3,235,926 and patent and non-patent literature referenced in the aforesaid patent documents.

### SUMMARY OF THE INVENTION

The present invention seeks to provide improved air filters and improved system and method for manufacture thereof.

There is thus provided in accordance with a preferred embodiment of the present invention an air filter including at least one filter medium including sonochemically-deposited at least one of nanoparticles having anti-microbial characteristics and microparticles having anti-microbial characteristics.

There is also provided in accordance with another preferred embodiment of the present invention an air filter including at least one filter medium including at least one of nanoparticles having anti-microbial characteristics and microparticles having anti-microbial characteristics and at least one additional filter medium adhered to the at least one filter medium including the at least one of nanoparticles having anti-microbial characteristics and microparticles having anti-microbial characteristics.

In accordance with a preferred embodiment of the present invention, the at least one additional filter medium includes a high-efficiency filter medium.

Preferably, the air filter also includes a layer of carbon particles retained between the at least one additional filter medium and the at least one filter medium including the at least one of nanoparticles having anti-microbial characteristics and microparticles having anti-microbial characteristics.

In accordance with a preferred embodiment of the present invention, the at least one filter medium includes sonochemically-deposited at least one of nanoparticles having anti-microbial characteristics and microparticles having anti-microbial characteristics.

In accordance with a preferred embodiment of the present invention, the at least one filter medium includes a non-woven polymer filter medium. Preferably, the at least one filter medium includes a non-woven polyester prefiltration mat. Preferably, the at least one filter medium includes a mesh.

Preferably, the air filter includes an injection-molded frame structure.

In accordance with a preferred embodiment of the present invention, the filter medium has a distribution of not less than 0.5 g of the at least one of the nanoparticles and the microparticles per square meter of the filter medium. Alternatively, in accordance with a preferred embodiment of the present invention, the filter medium has a distribution of not less than 1 g of the at least one of the nanoparticles and the microparticles per square meter of the filter medium.

In accordance with a preferred embodiment of the present invention, the filter medium has a thickness of 0.3 mm to 2.0 mm. Alternatively, in accordance with a preferred embodiment of the present invention, the filter medium has a thickness of 0.1 mm to 1.5 mm. Alternatively, in accordance with a preferred embodiment of the present invention, the filter medium has a thickness of 2 mm to 20 mm.

There is also provided in accordance with another preferred embodiment of the present invention a method for manufacturing an air filter including providing a roll of at least one filter medium, in a roll-to-roll manner, passing the at least one filter medium through a sonochemical bath for depositing therein at least one of nanoparticles having anti-microbial characteristics and microparticles having anti-microbial characteristics and thereafter, drying the at least one filter medium, including sonochemically-deposited at least one of nanoparticles having anti-microbial characteristics and microparticles having anti-microbial characteristics.

Preferably, the method also includes adhering at least one additional filter medium to the at least one filter medium including the at least one of nanoparticles having anti-microbial characteristics and microparticles having anti-microbial characteristics.

In accordance with a preferred embodiment of the present invention, the method also includes providing and retaining a layer of carbon particles between the at least one additional filter medium and the at least one filter medium including the at least one of nanoparticles having anti-microbial characteristics and microparticles having anti-microbial characteristics.

### BRIEF DESCRIPTION OF THE DRAWINGS

The present invention will be understood and appreciated more fully from the following detailed description, taken in conjunction with the drawings in which:

FIG. 1A is a simplified illustration of a system and method of manufacture of an air filter in accordance with a preferred embodiment of the present invention;

FIG. 1B is a simplified illustration of a system and method of manufacture of an air filter medium in accordance with another preferred embodiment of the present invention;

FIG. 1C is a simplified illustration of a system and method of manufacture of an air filter medium in accordance with yet another preferred embodiment of the present invention;

FIG. 1D is a simplified illustration of a system and method of manufacture of an air filter in accordance with still another preferred embodiment of the present invention;

FIG. 1E is a simplified illustration of a system and method of manufacture of an air filter in accordance with yet a further preferred embodiment of the present invention;

FIG. 2A/1 is a simplified illustration of an air filter produced by the system and method of FIG. 1A employing a side wall gluing machine;

FIG. 2A/2 is a simplified illustration of an air filter produced by the system and method of FIG. 1A employing an injection molding machine;

FIG. 2B is a simplified illustration of an air filter medium produced by the system and method of FIG. 1B;

FIG. 2C is a simplified illustration of an air filter medium produced by the system and method of FIG. 1C;

FIG. 2D/1 is a simplified illustration of an air filter produced by the system and method of FIG. 1D employing a side wall gluing machine;

FIG. 2D/2 is a simplified illustration of an air filter produced by the system and method of FIG. 1D employing an injection molding machine;

FIG. 2E/1 is a simplified illustration of an air filter produced by the system and method of FIG. 1E employing a side wall gluing machine;

FIG. 2E/2 is a simplified illustration of an air filter produced by the system and method of FIG. 1E employing an injection molding machine;

FIG. 3A is a simplified pictorial illustration of a sonochemical bath assembly preferably employed in the systems and methods of FIGS. 1A-1E; and

FIG. 3B is a simplified sectional illustration taken along the lines B-B in FIG. 3A.

### DETAILED DESCRIPTION OF PREFERRED EMBODIMENTS

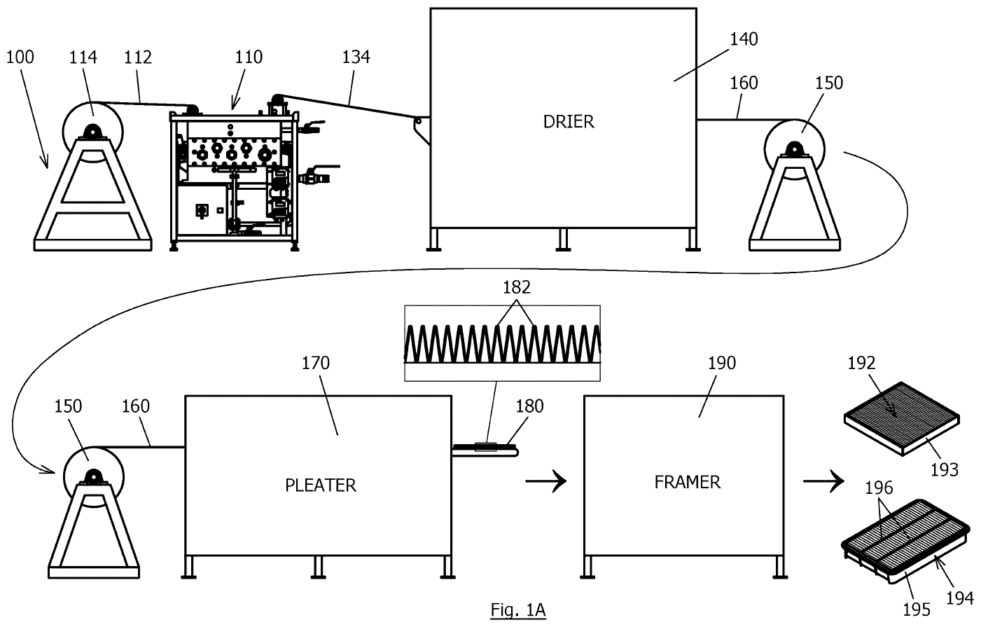

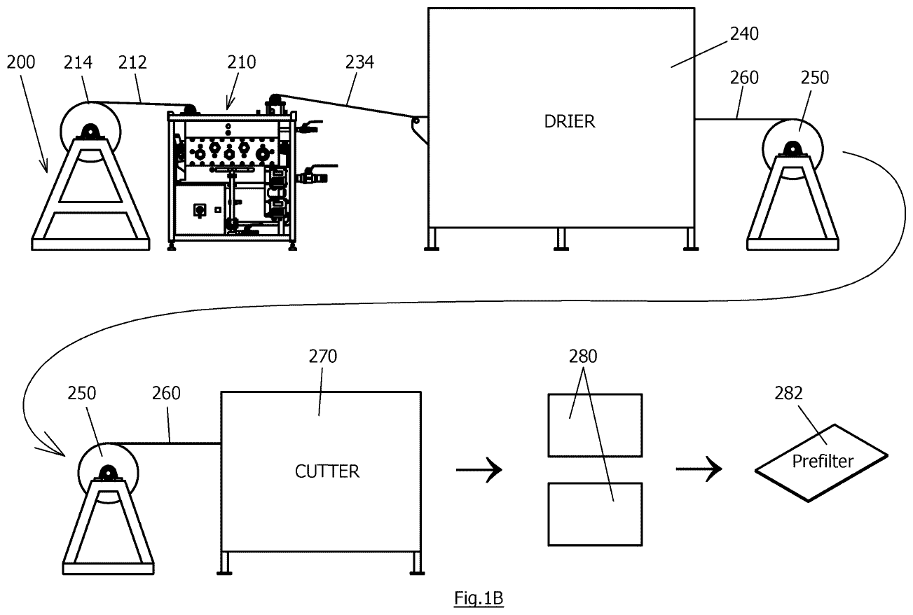

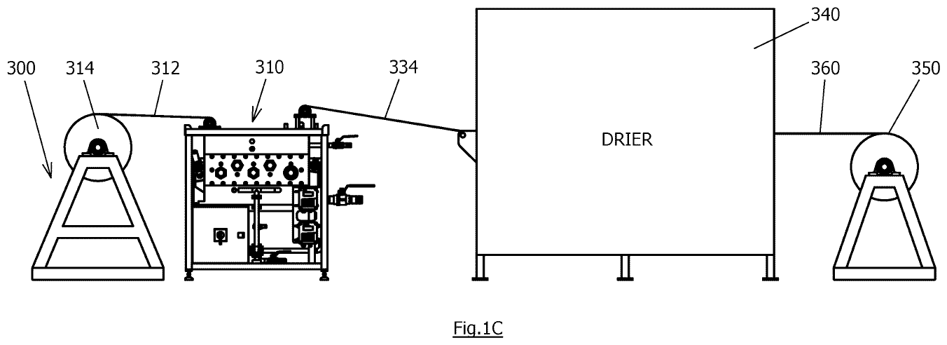

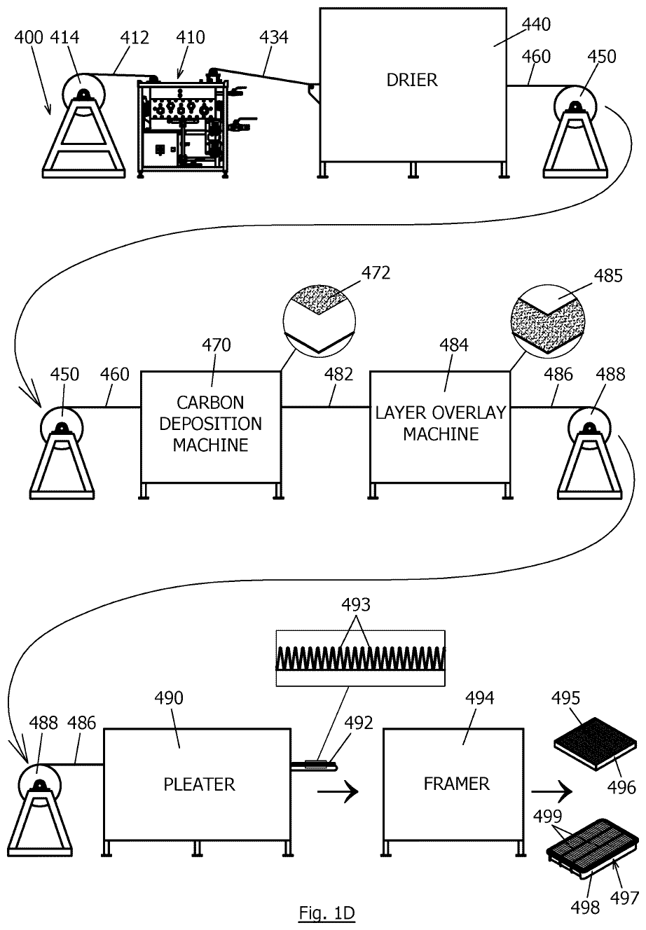

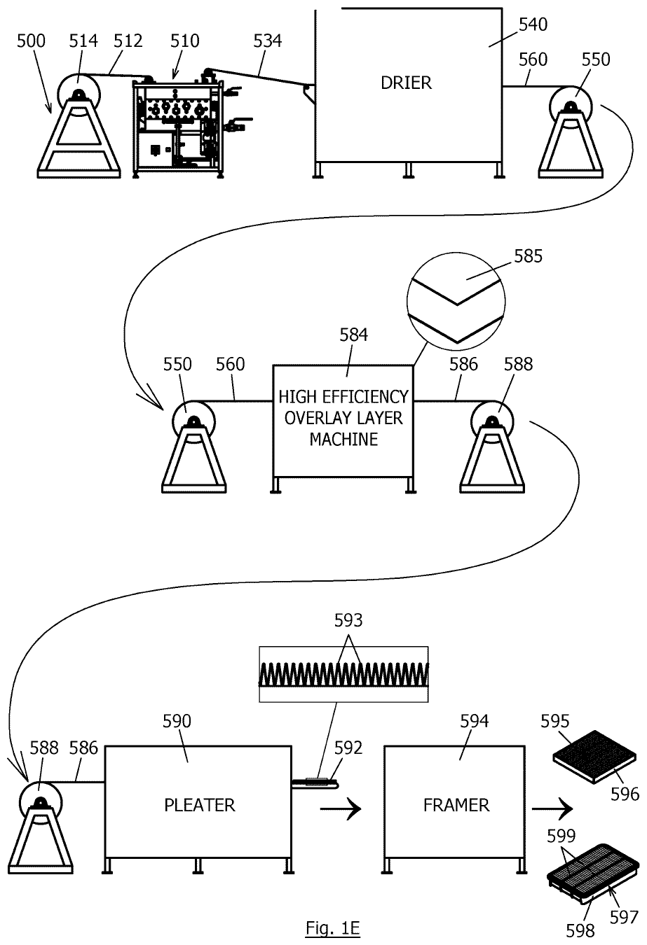

Reference is now made to FIG. 1A, which is a simplified illustration of a system 100 and method of manufacture of a pleated air filter in accordance with a preferred embodiment of the present invention. As seen in FIG. 1A, system 100 includes a sonochemical bath assembly 110, which preferably receives a continuous web of a filter medium 112 from a supply roll 114. Filter medium 112 is preferably a non-woven polymer filter medium, such as a non-woven polyester web, one example of which is HDF H19323, commercially available from Flic Slovenia, a subsidiary of Freudenberg of Germany.

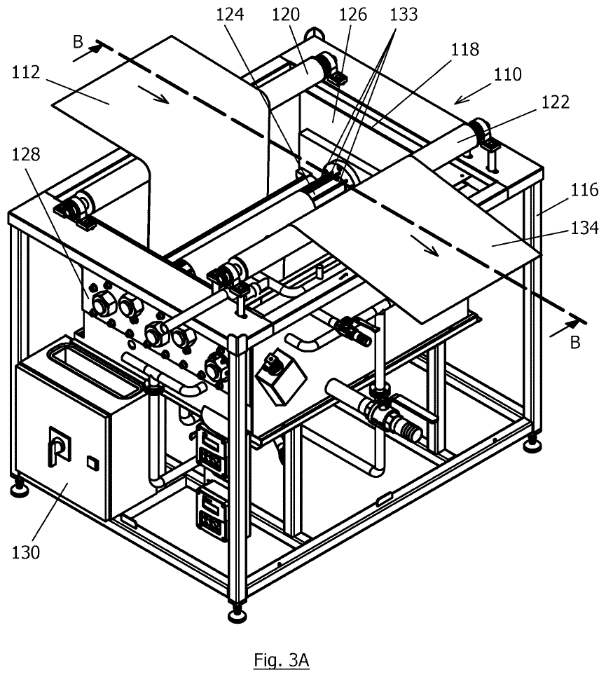

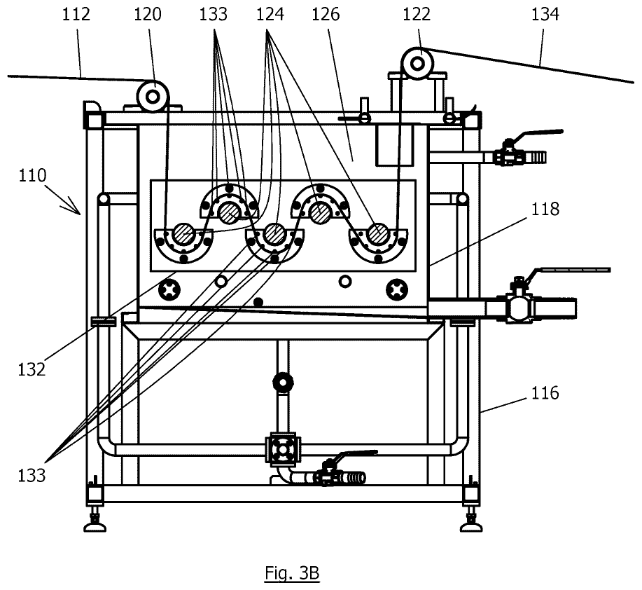

Sonochemical bath assembly 110 is shown in greater detail in FIGS. 3A and 3B and includes a chassis 116 onto which is mounted a bath 118. A bearing-mounted inlet roller 120 and a bearing-mounted outlet roller 122 are mounted onto chassis 116 at least partially overlying bath 118. A plurality of ultrasound generators, typically between two and five in number and here shown as five, are each located in one of a corresponding plurality of hollow transverse rods 124, which are in turn mounted onto mutually facing opposite walls 126 and 128. The operation of the ultrasonic generators is governed by a controller 130. The bath 118 is filled to a level above transverse rods 124 with a sonochemical treatment solution 132, which preferably contains at least one of nanoparticles having anti-microbial characteristics and microparticles having anti-microbial characteristics, such as metal oxide particles. One example of sonochemical treatment solution 132 is water containing CuO particles. Alternative solutions may include, inter alia, other metal oxide such as zinc oxide and silver oxide.

As seen particularly in FIG. 3B, filter medium 112 passes over inlet roller 120 into bath 118 and is wound past transverse rods 124 in the sonochemical treatment solution 132 and over outlet roller 122. Filter medium 112 is spaced from each of transverse rods 124 by a plurality of spacer rods 133, which are mounted onto mutually facing opposite walls 126 and 128 of bath 118 along about one half of the circumference of each of the transverse rods 124 and each spaced about 2 cm therefrom. The resulting sonochemical treatment produces impregnation of filter medium 112 with at least one of anti-microbial nanoparticles and anti-microbial microparticles in accordance with the teachings of one or more of the following publications, the disclosures of which are hereby incorporated by reference:
U.S. Pat. No. 9,315,937; U.S. Published Patent Application 2011/097957, PCT Published Patent Application WO 2014/181329; European Published patent application Ser. No. 17/166,865.0 and patent and non-patent literature referenced in the aforesaid patent documents.

Preferred operational parameters of bath assembly 110 which are particularly suitable for use with filter medium 112 are as follows:
sonochemical treatment solution: Deionized water containing CuO anti-microbial particles
solution concentration: approximately 2 g of CuO anti-microbial particles per liter of solution
size ranges of anti-microbial CuO particles: 0.001 μm to 1 μm
solution temperature: 30° C. to 70° C.
solution pH: 7.0 to 8.5
throughput speed of the filter medium: 0.5 meters/minute to 5 meters/minute.

Downstream of bath assembly 110, the sonochemically-treated filter medium 134 is dried in a drier 140 and then is preferably wound on a take-up roll 150. It is appreciated that the dried sonochemically-treated filter medium 160 is a filter medium including sonochemically-deposited at least one of nanoparticles having anti-microbial characteristics and microparticles having anti-microbial characteristics. Dried sonochemically-treated filter medium 160 is then fed to a pleater 170, such as a roller or knife pleater, for example a pleater commercially available from Doubelwin Co Ltd of Korea under catalog number DBWR-W800HS. The pleated dried sonochemically-treated filter medium 180 having a plurality of pleats 182 is then supplied to a framer 190, such as an injection molding machine, for example an injection molding machine commercially available from Daekyung Hydraulic Machinery Co. LTD Gyeonggi-do Korea (www.dkv2000.com) under catalog number DKV 12 EHS. Alternatively, framer 190 may be a side strip gluing machine, such as a machine commercially available from A2Z Filtration of Delhi, India (www.A2Zfiltration.com).

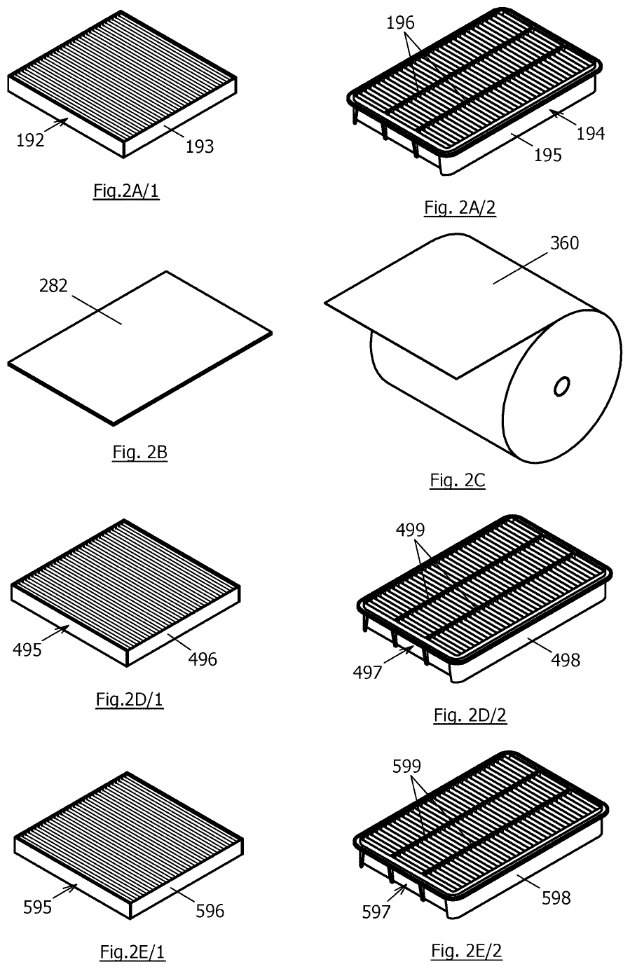

If a side strip gluing machine is employed as framer 190, the finished product is an air filter 192, also shown in FIG. 2A/1, which is particularly suitable for use in LV cabin air filters, air purifiers and HVSC systems, and which includes a plurality of side walls 193.

If an injection molding machine is employed as framer 190, the finished product is an air filter 194, also shown in FIG. 2A/2, which is particularly suitable for use in HD automotive cabin air filters, and which includes an integrally injection-molded frame structure 195 and a plurality of ribs 196.

Air filters 192 and 194 preferably each preferably have the following structural and operational parameters:
Thickness of dried sonochemically-treated filter medium 160:0.3 mm to 2.0 mm

Distribution of anti-microbial particles in the filter medium: not less than 0.5 g of CuO particles per square meter of filter medium.

Reference is now made to FIG. 1B, which is a simplified illustration of a system 200 and method of manufacture of an air filter medium in accordance with another preferred embodiment of the present invention. As seen in FIG. 1B, system 200 includes a sonochemical bath assembly 210, which preferably receives a continuous web of a filter medium 212 from a supply roll 214. Filter medium 212 is preferably a non-woven polyester prefiltration mat of thickness in the range of 2 mm to 20 mm, one example of which is designated as NU-M5, and is commercially available from Noam Urim of Israel.

Sonochemical bath assembly 210 is shown in greater detail in FIGS. 3A and 3B described above, which description is equally applicable to the embodiment of FIG. 1B.

Preferred operational parameters of bath assembly 210 which are particularly suitable for use with filter medium 212 are as follows:
sonochemical treatment solution: Deionized water containing CuO anti-microbial particles
solution concentration: approximately 2 g of Cu particles per liter of solution
size ranges of anti-microbial CuO particles: 0.001 μm to 1 μm
solution temperature: 30° C. to 70° C.
solution pH: 7.0 to 8.5
throughput speed of the filter medium: 0.5 meters/minute to 5 meters/minute.

Downstream of bath assembly 210, the sonochemically-treated filter medium 234 is dried in a drier 240 and then is preferably wound on a take-up roll 250. It is appreciated that the dried sonochemically-treated filter medium 260 is a filter medium including sonochemically-deposited at least one of nanoparticles having anti-microbial characteristics and microparticles having anti-microbial characteristics. Dried sonochemically-treated filter medium 260 is then fed to a cutter 270. The cut, dried sonochemically-treated filter medium 280 may then be supplied to customers for use, inter alia as a prefilter 282, an example of which is shown in FIG. 2B.

The cut, dried sonochemically-treated filter medium 280 preferably has the following structural and operational parameters:
Thickness: 2 mm to 20 mm

Distribution of anti-microbial particles in the filter medium: not less than 1 g of CuO particles per square meter of filter medium.

Reference is now made to FIG. 1C, which is a simplified illustration of a system 300 and method of manufacture of an air filter medium in accordance with another preferred embodiment of the present invention. As seen in FIG. 1C, system 300 includes a sonochemical bath assembly 310, which preferably receives a continuous web of a filter medium 312 from a supply roll 314. Filter medium 312 is preferably a plastic mesh of thickness in the range of 0.1 mm to 1.5 mm, one example of which is WN 0100, commercially available from Industrial Netting Inc. of the U.S.A.

Sonochemical bath assembly 310 is shown in greater detail in FIGS. 3A and 3B, described above, which description is equally applicable to the embodiment of FIG. 1C.

Preferred operational parameters of bath assembly 310 which are particularly suitable for use with filter medium 312 are as follows:
sonochemical treatment solution: Deionized water containing CuO anti-microbial particles
solution concentration: approximately 2 g of Cu particles per liter of solution
size ranges of anti-microbial CuO particles: 0.001 μm to 1 μm
solution temperature: 30° C. to 70° C.
solution pH: 7.0 to 8.5
throughput speed of the filter medium: 0.5 meters/minute to 5 meters/minute.

Downstream of bath assembly 310, the sonochemically-treated filter medium 334 is dried in a drier 340 and then is preferably wound on a take-up roll 350. It is appreciated that the dried sonochemically-treated filter medium 360 is a filter medium including sonochemically-deposited at least one of nanoparticles having anti-microbial characteristics and microparticles having anti-microbial characteristics. Dried sonochemically-treated filter medium 360 may then be supplied to customers for use, inter alia in roll form, an example of which is shown in FIG. 2C.

Dried sonochemically-treated filter medium 360 preferably has the following structural and operational parameters:
Thickness: 0.1 mm to 1.5 mm

Distribution of anti-microbial particles in the filter medium: not less than 1 g of CuO particles per square meter of the filter medium.

Reference is now made to FIG. 1D, which is a simplified illustration of a system 400 and method of manufacture of an air filter in accordance with yet another preferred embodiment of the present invention. As seen in FIG. 1D, system 400 includes a sonochemical bath assembly 410, which preferably receives a continuous web of a filter medium 412 from a supply roll 414. Filter medium 412 is preferably a non-woven polymer filter medium, such as a non-woven polyester web, one example of which is commercially available from Retop filtration Material Co. LTD Dongguan China (www.retopfiber.com) under catalog designator JTT 90.

Sonochemical bath assembly 410 is shown in greater detail in FIGS. 3A and 3B described above, which description is equally applicable to the embodiment of FIG. 1D

Preferred operational parameters of bath assembly 410 which are particularly suitable for use with filter medium 412 are as follows:
sonochemical treatment solution: Deionized water containing CuO anti-microbial particles
solution concentration: approximately 2 g of Cu particles per liter of solution
size ranges of anti-microbial CuO particles: 0.001 μm to 1 μm
solution temperature: 30° C. to 70° C.
solution pH: 7.0 to 8.5
throughput speed of the filter medium: 0.2 meters/minute to 3 meters/minute.

Downstream of bath assembly 410, the sonochemically-treated filter medium 434 is dried in a drier 440 and then is preferably wound on a take-up roll 450. It is appreciated that the dried sonochemically-treated filter medium 460 is a filter medium including sonochemically-deposited at least one of nanoparticles having anti-microbial characteristics and microparticles having anti-microbial characteristics. Dried sonochemically-treated filter medium 460 is then fed to a carbon particle deposition machine 470. Carbon particle deposition machine 470 preferably deposits onto dried sonochemically-treated filter medium 460 a layer of carbon particles 472, typically of thickness 1 mm to 5 mm. The dried sonochemically-treated filter medium having deposited thereon a layer of carbon particles, here designated 482, is then supplied to a retaining layer overlay machine 484 which adheres a layer of non-woven polyester web 485 onto dried sonochemically-treated filter medium 482 having deposited thereon a layer of carbon particle. Retaining layer overlay machine 484 adheres layer of non-woven polyester web 485 over layer of carbon particles 472, and layer of non-woven polyester web 485 preferably retains layer of carbon particles 472 on dried sonochemically-treated filter medium 482. The output of retaining layer overlay machine 484 is here termed a multi-layer dried sonochemically-treated filter medium having deposited thereon a layer of carbon particles and retaining layer 486, and may be rolled onto a take-up roll 488. It is appreciated that layer of non-woven polyester web 485 is a filter medium, and may be a high-efficiency filter medium, but need not be.

Multi-layer filter medium 486 is then fed to a pleater 490, such as a roller or knife pleater, for example a pleater commercially available from Doubelwin Co. Ltd. of Gyeonggi-do Korea (www.double-win.kr) under catalog number DBWR-800HS. The pleated dried sonochemically-treated filter medium 492 having a plurality of pleats 493 is then supplied to a framer 494, such as an injection molding machine, for example an injection molding machine commercially available from Daekyung Hydraulic Machinery Co. LTD Gyeonggi-do Korea (www.dkv2000.com) under catalog number DKV 12 EHS. Alternatively, framer 494 may be a side strip gluing machine, such as a machine commercially available from. A2Z Filtration of Delhi India (www.A2Zfiltration.com).

If a side strip gluing machine is employed as framer 494, the finished product is an air filter 495, also shown in FIG. 2D/1, which is particularly suitable for use in LV cabin air filters, air purifiers and HVSC systems, and which includes a plurality of side walls 496.

If an injection molding machine is employed as framer 494, the finished product is an air filter 497, also shown in FIG. 2D/2, which is particularly suitable for use in HD automotive cabin air filters, and which includes an integrally injection-molded frame structure 498 and a plurality of ribs 499.

Air filters 495 and 497 preferably each have the following structural and operational parameters:
Thickness of multi-layer filter medium 486: 2 mm to 8 mm

Distribution of anti-microbial particles in the filter medium: not less than 1 g of CuO particles per square meter of filter medium.

Reference is now made to FIG. 1E, which is a simplified illustration of a system 500 and method of manufacture of an air filter in accordance with still another preferred embodiment of the present invention. As seen in FIG. 1E, system 500 includes a sonochemical bath assembly 510, which preferably receives a continuous web of a filter medium 512 from a supply roll 514. Filter medium 512 is preferably a non-woven polymer filter medium, such as a non-woven polyester web, one example of which is commercially available from Retop filtration Material Co. LTD Dongguan China (www.retopfiber.com) under catalog designator JTT 90.

Sonochemical bath assembly 510 is shown in greater detail in FIGS. 3A and 3B described above, which description is equally applicable to the embodiment of FIG. 1E.

Preferred operational parameters of bath assembly 510 which are particularly suitable for use with filter medium 512 are as follows:
sonochemical treatment solution: Deionized water containing CuO anti-microbial particles
solution concentration: approximately 2 g of Cu particles per liter of solution
size ranges of anti-microbial CuO particles: 0.001 μm to 1 μm
solution temperature: 30° C. to 70° C.
solution pH: 7.0 to 8.5
throughput speed of the filter medium: 0.2 meters/minute to 4 meters/minute.

Downstream of bath assembly 510, the sonochemically-treated filter medium 534 is dried in a drier 540 and then is preferably wound on a take-up roll 550. It is appreciated that the dried sonochemically-treated filter medium 560 is a filter medium including sonochemically-deposited at least one of nanoparticles having anti-microbial characteristics and microparticles having anti-microbial characteristics. Dried sonochemically-treated filter medium 560 is then fed to a high-efficiency filter layer overlay machine 584 which adheres a layer of polyester fine fibers 585 of thickness 0.2 mm to 1.5 mm onto the dried sonochemically-treated filter medium 560. The output of layer overlay machine 584 is here termed a multi-layer high-efficiency dried sonochemically-treated filter medium 586 and may be rolled onto a take-up roll 588. It is appreciated that layer of polyester fine fibers 585 is a filter medium, and is preferably a high-efficiency filter medium.

Multi-layer filter medium 586 is then fed to a pleater 590, such as a roller or knife pleater, for example a pleater commercially available from Doubelwin Co. Ltd of Korea, under catalog number DBWR-800 HS. The pleated dried sonochemically-treated filter medium 592 having a plurality of pleats 593 is then supplied to a framer 594, such as an injection molding machine, for example an injection molding machine commercially available from Daekyung Hydraulic Machinery Co. LTD Gyeonggi-do Korea (www.dkv2000.com) under catalog number DKV 12 EHS. Alternatively, framer 594 may be a side strip gluing machine, such as a machine commercially available from A2Z Filtration of Delhi India (www.A2Zfiltration.com).

If a side strip gluing machine is employed as framer 594, the finished product is an air filter 595, also shown in FIG. 2E/1, which is particularly suitable for use in LV cabin air filters, air purifiers and HVSC systems, and which includes a plurality of side walls 596.

If an injection molding machine is employed as framer 594, the finished product is an air filter 597, also shown in FIG. 2E/2, which is particularly suitable for use in HD automotive cabin air filters, and which includes an integrally injection-molded frame structure 598 and a plurality of ribs 599.

Air filters 595 and 597 preferably each have the following structural and operational parameters:
Thickness of multi-layer filter medium 586: 2 mm to 8 mm

Distribution of anti-microbial particles in the filter medium: not less than 1 g of CuO particles per square meter of filter medium.

It will be appreciated by persons skilled in the art that the present invention is not limited by what has been particularly shown and described hereinabove. The scope of the present invention includes both combinations and subcombinations of various features described hereinabove as well as modifications thereof, all of which are not in the prior art, and are defined by the claims hereinbelow and their scope of equivalents.

1-21. (canceled)

22. An air filter comprising:
at least one filter medium including sonochemically-deposited at least one of nanoparticles having anti-microbial characteristics and microparticles having anti-microbial characteristics;
said at least one filter medium being fixed within a mountable frame associated with a mechanical air filtration system.

23. An air filter according to claim 22, and further comprising:
at least one additional filter medium adhered to said at least one filter medium including said at least one of nanoparticles having anti-microbial characteristics and microparticles having anti-microbial characteristics.

24. An air filter according to claim 23, and wherein said at least one additional filter medium comprises a high-efficiency filter medium.

25. An air filter according to claim 23, further comprising: a layer of carbon particles retained between said at least one additional filter medium and said at least one filter medium including said at least one of nanoparticles having anti-microbial characteristics and microparticles having anti-microbial characteristics.

26. An air filter according to claim 22, and wherein said at least one filter medium comprises a non-woven polymer filter medium.

27. An air filter according to claim 22, and wherein said at least one filter medium comprises a non-woven polyester prefiltration mat.

28. An air filter according to claim 22, and wherein said at least one filter medium comprises a mesh.

29. An air filter according to claim 22, and wherein said filter medium has a distribution of not less than 0.5 g of said at least one of said nanoparticles and said microparticles per square meter of said filter medium.

30. An air filter according to claim 22, and wherein said filter medium has a distribution of not less than 1 g of said at least one of said nanoparticles and said microparticles per square meter of said filter medium.

31. An air filter according to claim 22, and wherein said filter medium has a thickness of 0.3 mm to 2.0 mm.

32. An air filter according to claim 22, and wherein said filter medium has a thickness of 0.1 mm to 1.5 mm.

33. An air filter according to claim 22, and wherein said filter medium has a thickness of 2 mm to 20 mm.

34. An air filter according to claim 22, and wherein said mountable frame comprises an injection-molded frame structure.

35. An air filter according to claim 22, and wherein said mountable frame comprises strip-glued side walls.

36. An air filter according to claim 22, and wherein said at least one filter medium comprises a pleated filter medium.

37. An air filter according to claim 22, and wherein depositing said at least one of nanoparticles having anti-microbial characteristics and microparticles having anti-microbial characteristics on said at least one filter medium comprises:
providing a roll of said at least one filter medium;
in a roll-to-roll manner, passing said at least one filter medium through a sonochemical bath for depositing therein said at least one of nanoparticles having anti-microbial characteristics and microparticles having anti-microbial characteristics; and
thereafter, drying said at least one filter medium, including said sonochemically-deposited said at least one of nanoparticles having anti-microbial characteristics and microparticles having anti-microbial characteristics.

38. An air filter comprising:
at least one pleated filter medium including sonochemically-deposited at least one of nanoparticles having anti-microbial characteristics and microparticles having anti-microbial characteristics.

39. An air filter according to claim 38, further comprising: a mountable frame associated with a mechanical air filtration system, said at least one filter medium being fixed within said mountable frame.

40. An air filter according to claim 39, and wherein said mountable frame comprises an injection-molded frame structure.

41. An air filter according to claim 39, and wherein said mountable frame comprises strip-glued side walls.
